(19) United States
(12) Patent Application Publication
(10) Pub. No.: US 2026/0048794 A1
(43) Pub. Date: Feb. 19, 2026

(54) VEHICLE COWL STRUCTURE

(71) Applicant: Honda Motor Co., Ltd., Tokyo (JP)

(72) Inventors: Timothy J. Rupp, Dublin, OH (US); Chandra Mouli Murugesan, Marysville, OH (US); Douglas R. Kaltenmark, Powell, OH (US)

(21) Appl. No.: 18/807,179

(22) Filed: Aug. 16, 2024

(51) Int. Cl. B62D 25/08; B60J 1/02; B60S 1/34; B60S 1/52; B62D 25/04

(52) U.S. Cl. CPC B62D 25/081; B60J 1/02; B60S 1/3481; B60S 1/3493; B60S 1/52; B62D 25/04

(57) ABSTRACT

A vehicle cowl structure comprises a cowl top panel extending in a vehicle width direction along a lower end portion of a front windshield. The cowl top panel extends between a first side end and a second side end. The cowl top panel includes a top surface that slopes downwardly from the first side end to the second side end. The cowl top panel further includes a plurality of pivot holes spaced apart from each other and extending through the cowl top panel. The plurality of pivot holes is disposed on the top surface. Each pivot hole is adapted to receive a corresponding wiper shaft therethrough. Furthermore, the cowl top panel includes a plurality of islands spaced apart from each other and corresponding to the plurality of pivot holes. Each island of the plurality of islands is disposed proximal to a corresponding pivot hole of the plurality of pivot holes.

### BACKGROUND

The disclosed subject matter relates generally to a vehicle. More particularly, the disclosed subject matter relates to a vehicle cowl structure.

Recent vehicle design developments are more focused towards eliminating an underbody structure under a front wiper assembly of a vehicle. Conventionally, this underbody structure is used to manage and prevent ingress of water inside an engine compartment of the vehicle. Therefore, with elimination of the underbody structure, the vehicle may need wiper covers and various other parts to capture and control the water ingress through a cowl top surface. However, this approach not only increases manufacturing costs due to a requirement of multiple parts but also introduces complexity in assembly, which is undesirable.

### SUMMARY

In accordance with one embodiment of the present disclosure, a vehicle cowl structure is disclosed. The vehicle cowl structure comprises a cowl top panel extending in a vehicle width direction along a lower end portion of a front windshield. The cowl top panel extends between a first side end and a second side end. The cowl top panel includes a top surface that slopes downwardly from the first side end to the second side end. The cowl top panel further includes a plurality of pivot holes spaced apart from each other and extending through the cowl top panel. The plurality of pivot holes is disposed on the top surface. Each pivot hole is adapted to receive a corresponding wiper shaft therethrough. Furthermore, the cowl top panel includes a plurality of islands spaced apart from each other and corresponding to the plurality of pivot holes. Each island of the plurality of islands is disposed proximal to a corresponding pivot hole of the plurality of pivot holes. Each island extends upwardly from the top surface and includes a lateral surface that faces the corresponding pivot hole.

In accordance with another embodiment of the present disclosure, a vehicle front structure is disclosed. The vehicle front structure comprises a pair of pillars. The vehicle front structure further comprises a front windshield arranged between the pair of pillars and including a lower end portion. Furthermore, the vehicle front structure comprises a vehicle cowl structure. The vehicle cowl structure comprises a cowl top panel extending in a vehicle width direction along the lower end portion of the front windshield. The cowl top panel extends between a first side end and a second side end. The cowl top panel includes a top surface that slopes downwardly from the first side end to the second side end. The cowl top panel further includes a plurality of pivot holes spaced apart from each other and extending through the cowl top panel. The plurality of pivot holes is disposed on the top surface. Each pivot hole is adapted to receive a corresponding wiper shaft therethrough. Furthermore, the cowl top panel includes a plurality of islands spaced apart from each other and corresponding to the plurality of pivot holes. Each island of the plurality of islands is disposed proximal to a corresponding pivot hole of the plurality of pivot holes. Each island extends upwardly from the top surface and includes a lateral surface that faces the corresponding pivot hole.

In accordance with yet a further embodiment of the present disclosure, a vehicle is disclosed. The vehicle comprises a roof. The vehicle further comprises a vehicle front structure coupled to the roof and extending towards a front end of the vehicle. The vehicle front structure includes a pair of pillars. The vehicle front structure further includes a front windshield arranged between the pair of pillars and including a lower end portion. Furthermore, the vehicle front structure includes a vehicle cowl structure. The vehicle cowl structure includes a cowl top panel extending in a vehicle width direction along the lower end portion of the front windshield. The cowl top panel extends between a first side end and a second side end. The cowl top panel includes a top surface that slopes downwardly from the first side end to the second side end. The cowl top panel further includes a plurality of pivot holes spaced apart from each other and extending through the cowl top panel. The plurality of pivot holes is disposed on the top surface. Each pivot hole is adapted to receive a corresponding wiper shaft therethrough. Furthermore, the cowl top panel includes a plurality of islands spaced apart from each other and corresponding to the plurality of pivot holes. Each island of the plurality of islands is disposed proximal to a corresponding pivot hole of the plurality of pivot holes. Each island extends upwardly from the top surface and includes a lateral surface that faces the corresponding pivot hole.

### BRIEF DESCRIPTION OF THE DRAWINGS

Certain embodiments of the present disclosure will be better understood from the following description taken in conjunction with the accompanying drawings in which:

FIG. 1 is a perspective view of a vehicle, in accordance with an embodiment of the present disclosure;

FIG. 2 is a front perspective view of a vehicle front structure of the vehicle of FIG. 1, in accordance with an embodiment of the present disclosure;

FIG. 3 is a front perspective view of a vehicle cowl structure associated with the vehicle of FIG. 1, in accordance with an embodiment of the present disclosure;

FIG. 4 is a perspective view of the vehicle cowl structure of FIG. 3, in accordance with an embodiment of the present disclosure;

FIG. 5 is a sectional view of the vehicle cowl structure of FIG. 3 showing one of wiper pivot caps, in accordance with an embodiment of the present disclosure; and

FIG. 6 is a front view of the vehicle front structure of FIG. 2 showing a flow patten of water during a cleaning operation of a front windshield of the vehicle of FIG. 1, in accordance with an embodiment of the present disclosure.

### DETAILED DESCRIPTION OF EXEMPLARY EMBODIMENTS

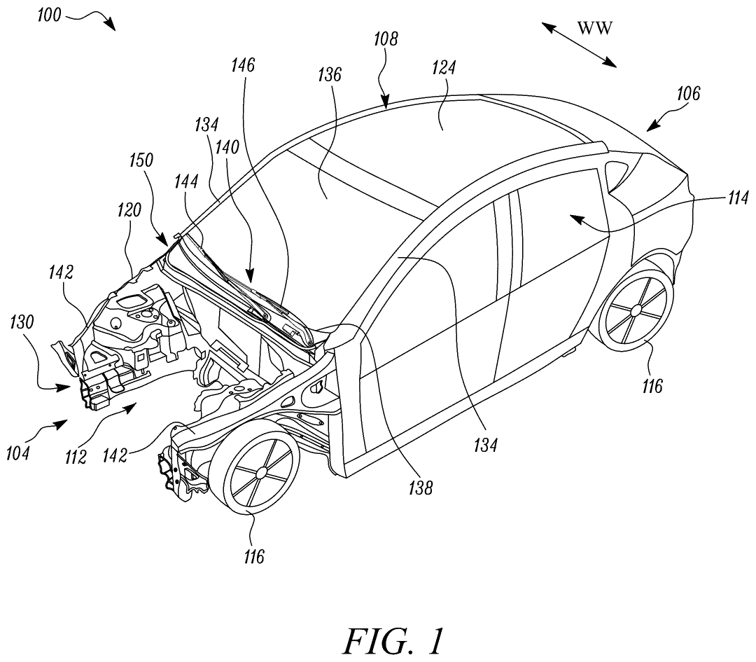

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-6, wherein like numbers indicate the same or corresponding elements throughout the views.

FIG. 1 illustrates a perspective view of a vehicle 100, in accordance with an embodiment of the present disclosure. As shown, the vehicle 100 includes a front end 104, a rear end 106, and a body structure 108 extending longitudinally from the front end 104 to the rear end 106. Further, the body structure 108 defines an engine compartment 112 and a passenger compartment 114 for facilitating seating of one or more passengers inside the vehicle 100. The vehicle 100 further includes a plurality of wheels 116 for supporting the body structure 108 on a ground surface (not shown) and enables a movement of the vehicle 100 over the ground surface. Although the vehicle 100 is shown as a sedan, it may be appreciated that the vehicle 100 may include any other type of vehicles, such as, but not limited to, coupes, sport utility vehicles (SUVs), bus etc.

Further, the vehicle 100 includes an underbody structure 120 having a floor (not shown) on which one or more seats (not shown) may be mounted. Further, the vehicle 100 includes a roof 124 disposed opposite to the floor (not shown). The vehicle 100 further includes a vehicle front structure 130 coupled to the roof 124 and extending towards the front end 104 of the vehicle 100. Further, the vehicle front structure 130 includes a pair of pillars 134. The pair of pillars 134 is illustrated as A-pillars supporting the roof 124 of the vehicle 100. The vehicle front structure 130 further includes a front windshield 136 arranged between the pair of pillars 134. The front windshield 136 includes a lower end portion 138 disposed towards a hood (not shown) of the vehicle 100.

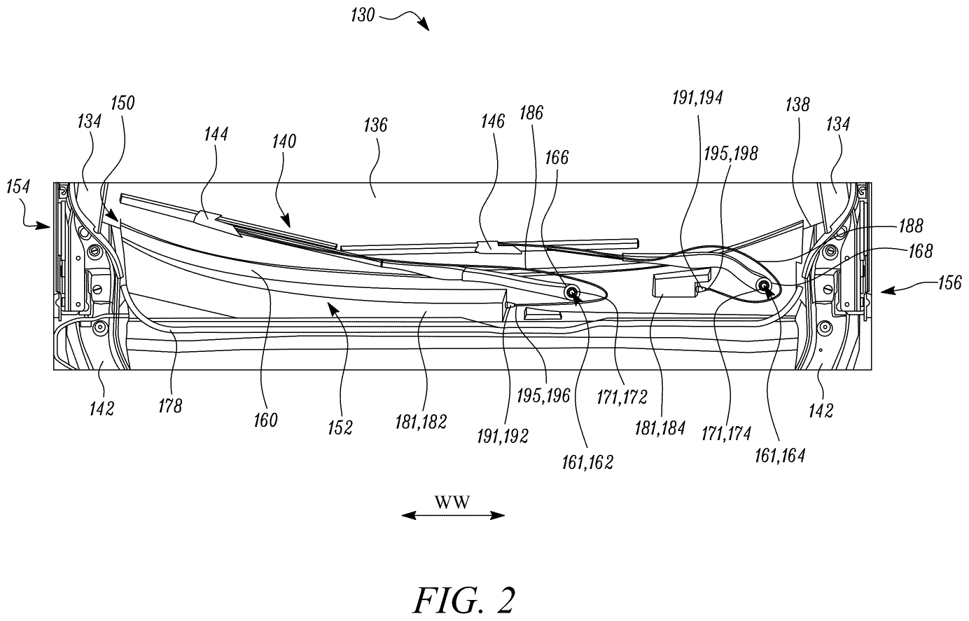

FIG. 2 illustrates a front perspective view of the vehicle front structure 130, in accordance with an embodiment of the present disclosure. The vehicle front structure 130 further includes a wiper assembly 140 to clean the front windshield 136 of the vehicle 100. The wiper assembly 140 includes a pair of wipers, for example, a first wiper 144 and a second wiper 146 pivotally coupled to a wiper motor (not shown) of the wiper assembly 140. Each of the first wiper 144 and the second wiper 146 oscillates between predefined positions across the front windshield 136 to perform a cleaning of the front windshield 136.

Furthermore, the vehicle front structure 130 includes a vehicle cowl structure 150 disposed adjacent to the front windshield 136. Specifically, the vehicle cowl structure 150 is disposed proximate to the lower end portion 138 of the front windshield 136.

The vehicle cowl structure 150 includes a cowl top panel 152 extending in a vehicle width direction WW along the lower end portion 138 of the front windshield 136. The cowl top panel 152 extends between the pair of pillars 134 of the vehicle 100 (shown in FIG. 1), such that each end of the cowl top panel 152 is supported by a damper assembly (not shown) disposed within side panels 142 of the vehicle 100.

The vehicle cowl structure 150 further includes a sealing element 178 coupled with the cowl top panel 152 towards a distal side from the front windshield 136. In some embodiments, the sealing element 178 may include a bulb seal to prevent the water ingress inside the engine compartment 112 (shown in FIG. 1) of the vehicle 100.

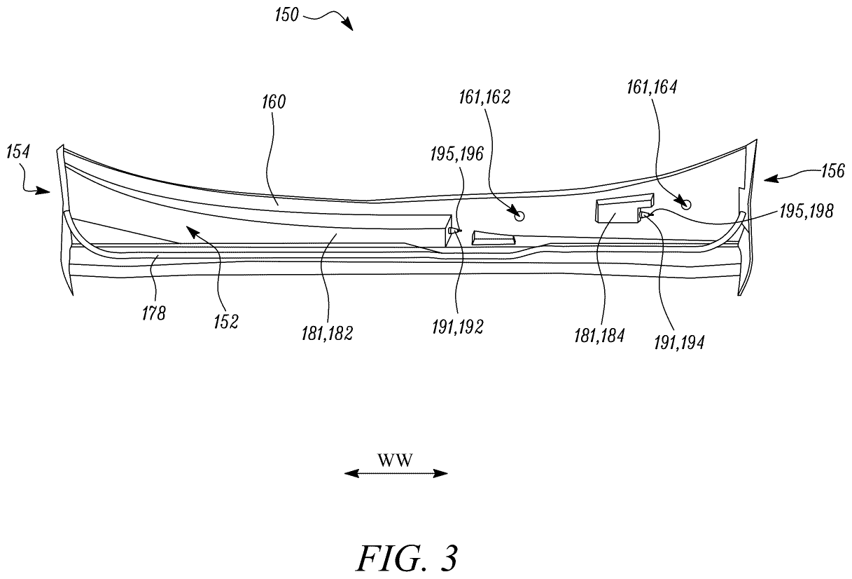

FIG. 3 illustrates a front perspective view of the vehicle cowl structure 150, in accordance with an embodiment of the present disclosure. As shown in FIGS. 2 and 3, the vehicle cowl structure 150 extends horizontally between the side panels 142 (as shown in FIG. 1) of the vehicle 100.

Referring to FIGS. 2 and 3, the cowl top panel 152 extends between a first side end 154 and a second side end 156. The cowl top panel 152 includes a top surface 160 that slopes downwardly from the first side end 154 to the second side end 156. In an example, the first side end 154 is illustrated as a driver side end and the second side end 156 is illustrated as an assistant (i.e., co-driver) side end. As the cowl top panel 152 slopes downwardly from the first side end 154 to the second side end 156, water may flow from the driver side end to the assistant side end, accordingly. In another example, the first side end 154 may be the assistant side end and the second side end 156 may be the driver side end and accordingly a flow direction of the water may change from the assistant side end to the driver side end.

The cowl top panel 152 further includes a plurality of pivot holes 161 spaced apart from each other and extending through the cowl top panel 152. The plurality of pivot holes 161 is disposed on the top surface 160. In the illustrated embodiment of FIGS. 2 and 3, the plurality of pivot holes 161 includes a first pivot hole 162 disposed proximal to the first side end 154 and a second pivot hole 164 disposed proximal to the second side end 156.

Each pivot hole 161 is adapted to receive a corresponding wiper shaft therethrough. In the illustrated example, the first pivot hole 162 and the second pivot hole 164 are adapted to receive a first wiper shaft 166 and a second wiper shaft 168, respectively.

The vehicle cowl structure 150 further includes a plurality of wiper pivot caps 171 (shown in FIG. 2) corresponding to the plurality of pivot holes 161 and sealingly coupled to the cowl top panel 152. In the illustrated embodiment of FIG. 2, two wiper pivot caps, for example, a first wiper pivot cap 172 corresponding to the first pivot hole 162 and a second wiper pivot cap 174 corresponding to the second pivot hole 164 sealingly coupled to the cowl top panel 152 are shown.

Each wiper pivot cap 171 of the plurality of wiper pivot caps 171 is disposed around a corresponding pivot hole 161 of the plurality of pivot holes 161. For example, each of the first wiper pivot cap 172 and the second wiper pivot cap 174 of the plurality of wiper pivot caps 171 is disposed around the first pivot hole 162 and the second pivot hole 164, respectively.

Furthermore, the cowl top panel 152 includes a plurality of islands 181 spaced apart from each other and corresponding to the plurality of pivot holes 161. In the illustrated embodiment of FIGS. 1 and 2, the plurality of islands 181 includes a first island 182 corresponding to the first pivot hole 162 and a second island 184 corresponding to the second pivot hole 164. Each island 181 of the plurality of islands 181 is disposed proximal to a corresponding pivot hole 161 of the plurality of pivot holes 161. For example, the first island 182 is disposed proximal to the first pivot hole 162 and the second island 184 is disposed proximal to the second pivot hole 164.

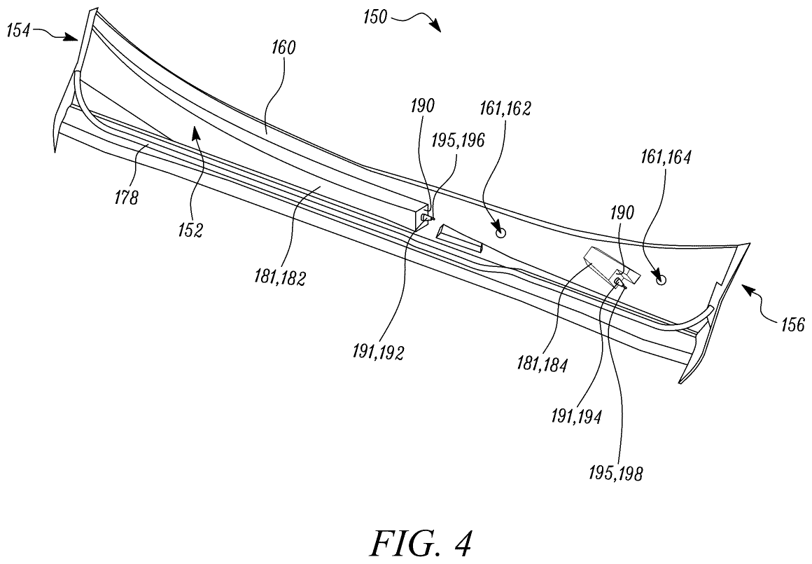

Referring now to FIG. 4, a perspective view of the vehicle cowl structure 150 is shown, in accordance with an embodiment of the present disclosure. The first island 182 and the second island 184 are arranged on the cowl top panel 152 such that the second island 184 is located higher than the first island 182 relative to the sealing element 178.

Each island 181 extends upwardly from the top surface 160 and includes a lateral surface 190 that faces the corresponding pivot hole 161. As shown in FIG. 4, each of the first island 182 and the second island 184 extends upwardly from the top surface 160 and includes the lateral surface 190.

Furthermore, the vehicle cowl structure 150 includes a plurality of washer grommets 191 corresponding to the plurality of islands 181. Each washer grommet 191 is coupled to a corresponding island 181 of the plurality of islands 181. In the illustrated embodiment of FIGS. 2 to 4, two washer grommets, a first washer grommet 192 and a second washer grommet 194 corresponding to the first island 182 and the second island 184, respectively, are shown. The first washer grommet 192 and the second washer grommet 194 are coupled to the first island 182 and the second island 184, respectively. Each washer grommet 191 (e.g., the first and second washer grommets 192, 194) extends from the lateral surface 190 of the corresponding island 181 (i.e., the first island 182 and the second island 184, respectively) towards the corresponding pivot hole 161 (i.e., the first pivot hole 162 and the second pivot hole 164, respectively).

Moreover, the vehicle cowl structure 150 includes a plurality of water delivery nipples 195 corresponding to each of the plurality of islands 181. As shown in FIGS. 2 to 4, two water delivery nipples, a first water delivery nipple 196 and a second water delivery nipple 198 corresponding to the first island 182 and the second island 184, respectively, are shown.

Each water delivery nipple 195 is coupled to a corresponding island 181 of the plurality of islands 181. For example, the first water delivery nipple 196 and the second water delivery nipple 198 are coupled to the first island 182 and the second island 184, respectively.

Each water delivery nipple 195 extends from the lateral surface 190 of the corresponding island 181 towards the corresponding pivot hole 161. For example, the first water delivery nipple 196 and the second water delivery nipple 198 extend from the lateral surface 190 of the first island 182 and the second island 184, respectively towards the respective first pivot hole 162 and the second pivot hole 164.

Additionally, the vehicle cowl structure 150 includes a plurality of delivery tubes, for example, a first delivery tube 186 (shown in FIG. 2) corresponding to the first water delivery nipple 196 and a second delivery tube 188 (shown in FIG. 2) corresponding to the second water delivery nipple 198. Each of the water delivery nipples 195 is adapted to transfer a cleaning liquid, preferably distilled water, from the corresponding islands to the associated wipers via the corresponding delivery tubes. In some embodiments, the plurality of islands 181 may act as the cleaning liquid storage to store/carry the cleaning liquid.

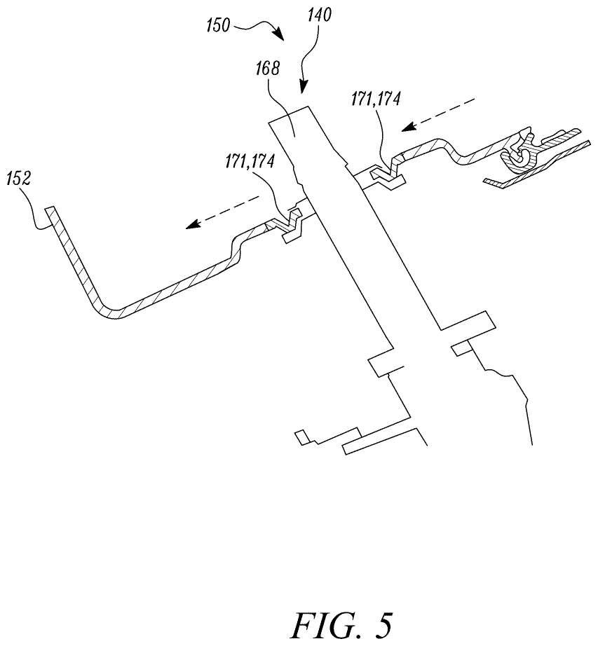

Referring to FIG. 5, a sectional view of the vehicle cowl structure 150 showing one of the plurality of wiper pivot caps 171 (i.e., the second wiper pivot cap 174) is shown, in accordance with an embodiment of the present disclosure. As shown in FIG. 5, the wiper pivot cap 174 prevents ingress of the water through the corresponding pivot hole 164 of the cowl top panel 152 inside the engine compartment 112 (shown in FIG. 1) of the vehicle 100 (shown in FIG. 1), thereby ensuring protection of water-sensitive components of the vehicle 100. As shown in FIG. 5, the water flows towards the downward slope side end (i.e., the second side end 154) of the vehicle 100, as the water pivot cap 174 prevents ingress of the water through the corresponding pivot hole 164 of the cowl top panel 152.

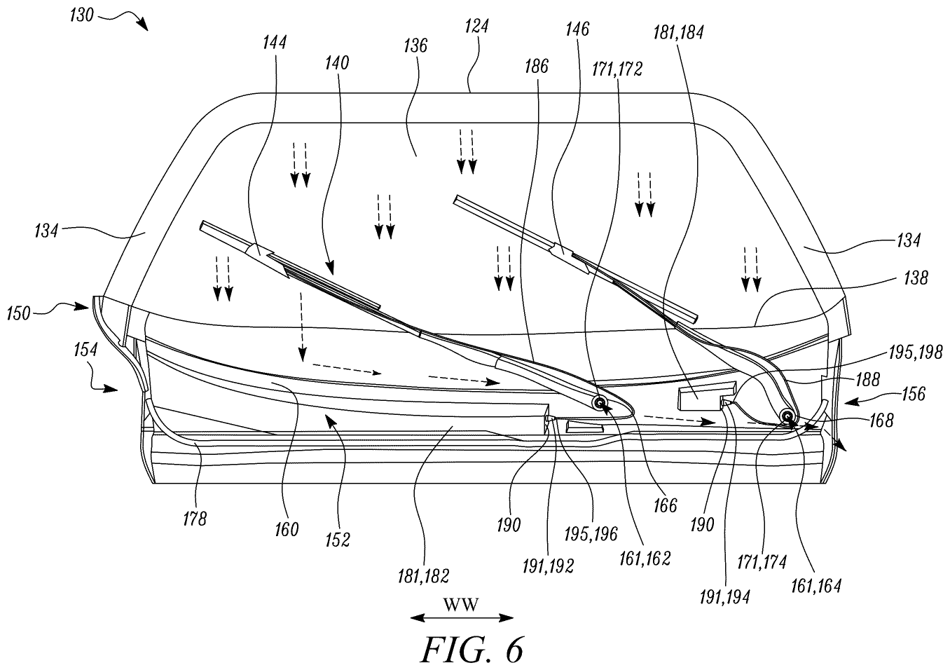

Referring to FIG. 6, a front view of the vehicle front structure 130 showing a flow patten of the water during a cleaning operation of the front windshield 136 is shown, in accordance with an embodiment of the present disclosure. As the wiper assembly 140 is actuated, the water starts flowing from the plurality of islands 181 to the corresponding wipers 144, 146 via the associated delivery tubes 186, 188 to facilitate the cleaning of the front windshield 136. During the cleaning operation, the water starts flowing on the front windshield 136 of the vehicle 100 and each of the first wiper 144 and the second wiper 146 starts swinging/oscillating back and forth, thereby cleaning the front windshield 136.

Upon performing the cleaning operation of the front windshield 136, the water starts flowing downwards under an action of gravity and may start to accumulate in the cowl top panel 152 of the vehicle 100. However, the top surface 160 of the cowl top panel 152 is sloped downwardly from the first side end 154 to the second side end 156. Therefore, the accumulated water starts flowing from the first side end 154 to the second side end 156. Accordingly, the water is guided towards the second side end 156. In other words, the water is guided away from the water-sensitive components of the vehicle 100 disposed in the engine compartment 112 (shown in FIG. 1) of the vehicle 100.

Moreover, the vehicle cowl structure 150 includes the plurality of wiper pivot caps 171 and the sealing element 178 to prevent ingress of the water towards the water-sensitive components disposed inside the engine compartment 112 of the vehicle 100. This may prevent any damage to the water-sensitive components of the vehicle 100, while ensuring a safe operation of all the components of the vehicle 100. Therefore, the plurality of wiper pivot caps 171 and the sealing element 178 eliminates a need of other components, such as, wiper covers to prevent the ingress of the water inside the engine compartment 112 through the cowl top panel 152, which results in lower associated costs.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto.

What is claimed is:

1. A vehicle cowl structure comprising:
a cowl top panel extending in a vehicle width direction along a lower end portion of a front windshield, wherein the cowl top panel extends between a first side end and a second side end, the cowl top panel including:
a top surface that slopes downwardly from the first side end to the second side end;
a plurality of pivot holes spaced apart from each other and extending through the cowl top panel, wherein the plurality of pivot holes is disposed on the top surface, and wherein each pivot hole is adapted to receive a corresponding wiper shaft therethrough; and
a plurality of islands spaced apart from each other and corresponding to the plurality of pivot holes, wherein each island of the plurality of islands is disposed proximal to a corresponding pivot hole of the plurality of pivot holes, and wherein each island extends upwardly from the top surface and includes a lateral surface that faces the corresponding pivot hole.

2. The vehicle cowl structure of claim 1, further comprising a plurality of washer grommets corresponding to the plurality of islands, wherein each washer grommet is coupled to a corresponding island of the plurality of islands, and wherein each washer grommet extends from the lateral surface of the corresponding island towards the corresponding pivot hole.

3. The vehicle cowl structure of claim 1, further comprising a plurality of wiper pivot caps corresponding to the plurality of pivot holes and sealingly coupled to the cowl top panel, wherein each wiper pivot cap of the plurality of wiper pivot caps is disposed around a corresponding pivot hole of the plurality of pivot holes.

4. The vehicle cowl structure of claim 1, further comprising a plurality of water delivery nipples corresponding to each of the plurality of islands, wherein each water delivery nipple is coupled to a corresponding island of the plurality of islands, and wherein each water delivery nipple extends from the lateral surface of the corresponding island towards the corresponding pivot hole.

5. The vehicle cowl structure of claim 1, further comprising a sealing element coupled with the cowl top panel towards a distal side from the front windshield.

6. The vehicle cowl structure of claim 5, wherein the plurality of islands includes a first island and a second island such that the second island is located higher than the first island relative to the sealing element on the top surface.

7. The vehicle cowl structure of claim 1, wherein the plurality of pivot holes includes a first pivot hole disposed proximal to the first side end and a second pivot hole disposed proximal to the second side end.

8. A vehicle front structure comprising:
a pair of pillars;
a front windshield arranged between the pair of pillars and including a lower end portion; and
a vehicle cowl structure disposed adjacent to the front windshield, wherein the vehicle cowl structure includes:
a cowl top panel extending in a vehicle width direction along the lower end portion of the front windshield, wherein the cowl top panel extends between a first side end and a second side end, the cowl top panel including:
a top surface that slopes downwardly from the first side end to the second side end;
a plurality of pivot holes spaced apart from each other and extending through the cowl top panel, wherein the plurality of pivot holes is disposed on the top surface, and wherein each pivot hole is adapted to receive a corresponding wiper shaft therethrough; and
a plurality of islands spaced apart from each other and corresponding to the plurality of pivot holes, wherein each island of the plurality of islands is disposed proximal to a corresponding pivot hole of the plurality of pivot holes, and wherein each island extends upwardly from the top surface and includes a lateral surface that faces the corresponding pivot hole.

9. The vehicle front structure of claim 8, further comprising a plurality of washer grommets corresponding to the plurality of islands, wherein each washer grommet is coupled to a corresponding island of the plurality of islands, and wherein each washer grommet extends from the lateral surface of the corresponding island towards the corresponding pivot hole.

10. The vehicle front structure of claim 8, further comprising a plurality of wiper pivot caps corresponding to the plurality of pivot holes and sealingly coupled to the cowl top panel, wherein each wiper pivot cap of the plurality of wiper pivot caps is disposed around a corresponding pivot hole of the plurality of pivot holes.

11. The vehicle front structure of claim 8, further comprising a plurality of water delivery nipples corresponding to each of the plurality of islands, wherein each water delivery nipple is coupled to a corresponding island of the plurality of islands, and wherein each water delivery nipple extends from the lateral surface of the corresponding island towards the corresponding pivot hole.

12. The vehicle front structure of claim 8, further comprising a sealing element coupled with the cowl top panel towards a distal side from the front windshield.

13. The vehicle front structure of claim 12, wherein the plurality of islands includes a first island and a second island such that the second island is located higher than the first island relative to the sealing element.

14. The vehicle front structure of claim 8, wherein the plurality of pivot holes includes a first pivot hole disposed proximal to the first side end and a second pivot hole disposed proximal to the second side end.

15. A vehicle comprising:
a roof,
a vehicle front structure coupled to the roof and extending towards a front end of the vehicle, the vehicle front structure including:
a pair of pillars;
a front windshield arranged between the pair of pillars and including a lower end portion; and
a vehicle cowl structure disposed adjacent to the front windshield, wherein the vehicle cowl structure includes:
a cowl top panel extending in a vehicle width direction along the lower end portion of the front windshield, wherein the cowl top panel extends between a first side end and a second side end, the cowl top panel including:
a top surface that slopes downwardly from the first side end to the second side end;
a plurality of pivot holes spaced apart from each other and extending through the cowl top panel, wherein the plurality of pivot holes is disposed on the top surface, and wherein each pivot hole is adapted to receive a corresponding wiper shaft therethrough; and
a plurality of islands spaced apart from each other and corresponding to the plurality of pivot holes, wherein each island of the plurality of islands is disposed proximal to a corresponding pivot hole of the plurality of pivot holes, and wherein each island extends upwardly from the top surface and includes a lateral surface that faces the corresponding pivot hole.

16. The vehicle of claim 15, further comprising a plurality of washer grommets corresponding to the plurality of islands, wherein each washer grommet is coupled to a corresponding island of the plurality of islands, and wherein each washer grommet extends from the lateral surface of the corresponding island towards the corresponding pivot hole.

17. The vehicle of claim 15, further comprising a plurality of wiper pivot caps corresponding to the plurality of pivot holes and sealingly coupled to the cowl top panel, wherein each wiper pivot cap of the plurality of wiper pivot caps is disposed around a corresponding pivot hole of the plurality of pivot holes.

18. The vehicle of claim 15, further comprising a plurality of water delivery nipples corresponding to each of the plurality of islands, wherein each water delivery nipple is coupled to a corresponding island of the plurality of islands, and wherein each water delivery nipple extends from the lateral surface of the corresponding island towards the corresponding pivot hole.

19. The vehicle of claim 15, further comprising a sealing element coupled with the cowl top panel towards a distal side from the front windshield.

20. The vehicle of claim 19, wherein the plurality of islands includes a first island and a second island such that the second island is located higher than the first island relative to the sealing element.
